(19) United States
(12) Patent Application Publication
(10) Pub. No.: US 2005/0214199 A1
(43) Pub. Date: Sep. 29, 2005

(54) Manganese compound, process for producing the same, and method of utilization of the same

(75) Inventors: Nobuyoshi Hayashi, Yamaguchi (JP); Yasushi Shioya, Toyama (JP); Hiroshi Wada, Tokyo (JP)

Correspondence Address: PILLSBURY WINTHROP SHAW PITTMAN, LLP, P.O. BOX 10500, MCLEAN, VA, 22102, US

(73) Assignee: Sued-Chemie Catalysts Japan, Inc, Tokyo (JP)

(21) Appl. No.: 10/522,029

(22) PCT Filed: Jul. 26, 2002
(86) PCT No.: PCT/JP02/07631

§ 371 Date: Jan. 21, 2005

(51) Int. Cl. C01G 45/12

(52) U.S. Cl. 423/599

(57) ABSTRACT

A manganese compound exerting a higher environmental pollutant removal performance than that of a conventional manganese oxide is provided. The manganese compound is obtained by mixing and reacting a bivalent manganese salt aqueous solution and a permanganate alkaline aqueous solution containing a quantity of an alkali larger than a stoichiometric quantity. When comparing the manganese compound with an already-known manganese oxide, it is determined that a specific surface area has significantly increased, and the environment pollutant removal performance is significantly improved. The manganese compound according to the present invention has a high specific surface area value and a high environment pollutant removal performance, and is useful in the adsorption and oxidation-removal of the odor components discharged from factories, NOx, SOx, VOC, and the unburned components such as hydrocarbons, aldehydes and the like which are generated by incomplete combustion.

### TECHNICAL FIELD

Present invention relates to a manganese compound used for removing environmental pollutants by adsorption and oxidation, a method of producing the same, and a method of using the same. Specifically, the present invention relates to the manganese compound used for adsorbing and oxidation-removing odor components, NOx, SOx, VOC, and furthermore, hydrocarbons, aldehydes and the like which are generated as unburned components by incomplete combustion of combustion exhaust gases, the method of producing the same, and the method of using the same.

### BACKGROUND ART

Conventionally, adsorbents such as active carbon and zeolite have been used to remove environmental pollutants such as, for example, the odor of tobacco in buildings and the interior of cars and the odor generated from raw garbage. Generally, the removal of odor by these adsorbents has been mainly implemented by physical adsorption wherein an odorant is adsorbed into the adsorbent.

In regards to a removing agent mainly comprising a manganese compound, Japanese Patent Laid-Open Publication No. 3-186317 discloses that a potassium permanganate aqueous solution and a manganese sulfate aqueous solution containing sulfuric acid are mixed and are reacted under the condition of strong acidity so as to allow manganese oxide (surface area: 240 m²/g) to catch and remove sulfur compounds.

Furthermore, Japanese Patent Laid-Open Publication 8-173765 discloses a manganese oxide (surface area: 84 to 185 m²/g) obtained that manganese carbonate is thermally decomposed and then treated with a nitric acid, and a manganese oxide (surface area: 204 m²/g) obtained that potassium permanganate aqueous solution and manganese nitrate aqueous solution are mixed and reacted, work as an adsorbent to remove the offensive odor of sulfur compounds.

However, if the adsorbent is used to remove environmental pollutants, a disadvantage exists in that the process for replacing the adsorbent or the like will be additionally required since its adsorption capacity is limited. In addition, there also exists a disadvantage in that a physically adsorbed substance is desorbed due to fluctuations in conditions such as temperature and pressure.

On the other hand, a method other than adsorption, that is, one which uses a manganese compound, manganese oxide in particular, as an oxidation catalyst, is known. It is also known that this catalyst has the capability to act even at temperatures in the vicinity of room temperature and, in general, a large surface area is preferable.

However, if a conventional manganese compound, as stated above, is used to remove environmental pollutants, the removal effect is not yet sufficient, and therefore, the development of a removing agent showing a higher performance has been desired.

The purpose of the present invention is, therefore, to provide a manganese compound which has a significantly higher environmental pollutant removal performance than that of a conventional compound.

### DISCLOSURE OF THE INVENTION

The inventors of the present invention found it necessary to allow manganese oxide to have a large surface area to achieve the afore-mentioned purpose, and thoroughly studied a method for preparing a manganese compound with a large surface area which has not yet appeared in the prior art.

As a result, the inventors have found that if the BET surface area of a manganese compound is 300 m²/g or more by incorporating an alkaline substance of 1 to 10% into the structure of the substance, the compound has a high adsorption capacity and oxidation catalyst performance.

Furthermore, the inventors have found that the manganese compound of the present invention can be produced by a method of producing a manganese compound wherein an alkali compound and a permanganate are mixed into a bivalent manganese salt aqueous solution under being stirred to produce precipitates by reaction, and the precipitates are filtered after sufficient washing, and then dried, which is characterized in that a quantity of the alkali compound is larger than a stoichiometric quantity to a permanganate.

In addition, the inventors have found that, after the removal tests had been performed by the method wherein gas containing environmental pollutants is passed through and contacts the obtained manganese compound, and said pollutants in the gas are removed from the gas, the manganese compound according to the present invention has a high removal performance, and the present invention has been completed.

The present invention relates to a newly manganese compound, characterized in that BET surface area thereof is 300 m²/g or more, and is preferably 350 m²/g or more. In addition, the content of the alkaline substance in the manganese compound according to the present invention is in the range of 1 to 10% to the total weight of the compound, and more preferably in the range of 3 to 9%.

Furthermore, the present invention relates to a method for producing a manganese compound which, specifically, is characterized, for example, in that a bivalent manganese salt aqueous solution (A solution) and a permanganic acid alkaline aqueous solution (B solution), to which a quantity of alkali compound larger than the stoichiometric quantity to permanganate is added, are prepared, the B solution is added to the A solution under being stirred, to produce precipitates by reaction, and the precipitates are filtered sufficient washing and then dried at a temperature of 100 to 200° C.

Here, it is preferable that nitrate, sulfate, chloride, or the like is used as the bivalent manganese salt, and it is preferable that sodium salt, potassium salt, or the like is used as the permanganate. In addition, it is preferable that hydroxide or carbonate of sodium, potassium, lithium or the like is used as the alkali compound for enabling an alkali of more than the stoichiometric quantity to permanganic acid to be present in the solution.

In addition, the added quantity of the alkali compound to the permanganate is, expressed in the mol ratio to alkali permanganate of 1 mol, preferably in the range of higher than 1.0 but 4.0 or less. If this ratio is 1.0 or less, the quantity of the alkali compound is too scarce, and the manganese compound with a large surface area can ultimately not be obtained. Also, if the ratio is higher than 4, the compound with a large surface area cannot be obtained. It is unnecessary to prepare the permanganate and alkali compound that are to be mixed with the A solution in an aqueous condition beforehand, and for example, a mixed powder of the required quantities of the permanganate and the alkali compound may be added to the A solution under being stirred.

Moreover, it is preferable that the drying temperature is 100 to 200° C., and more preferably 120 to 170° C. If the drying temperature is lower than 100° C., it is not practical since it takes a longer time to dry, and if the temperature is higher than 200° C., it is not preferable since the surface area of the manganese compound will deteriorate.

The BET surface area of the manganese compound thus obtained was more than 300 m²/g. Upon chemical analyzing the manganese compound according to the present invention, it was found that vast amounts of alkali were contained therein. Since the manganese compound according to the present invention is obtained by drying the reactant after the reactant has been sufficiently washed, it was found that the alkali is not mixed in as an impurity, but is incorporated into the structure of the substance. Therefore, it is considered that the manganese compound according to the present invention is not a manganese oxide but a type of compound comprising the components of alkali, manganese and oxygen.

Furthermore, the present invention relates to a method for removing environmental pollutants in a gas by enabling the gas containing the environmental pollutants to pass through and contact the manganese compound according to the present invention. Ammonia, hydrogen sulfide, mercaptans, aldehydes, carbon monoxide; and the like can be given as environmental pollutants.

Although the environmental pollutants are generally removed with a flow-type reactor, other methods may be used. Furthermore, the removal of the environmental pollutants is performed by a method wherein the manganese compound according to the present invention is filled in a reaction tube which is placed in a device, the gas containing the environmental pollutants is fed into the reaction tube, and the pollutants are removed by contact removal. The environmental pollutant removal performance is determined by measuring the concentration of the environmental pollutants on the outlet side of the reaction tube and calculating the deterioration rate to the concentration thereof on the inlet side. When the removal rate of the environmental pollutants for the manganese compound according to the present invention was measured and compared with that of the manganese oxide obtained by an already known method, it was confirmed that the manganese compound according to the present invention shows a significantly higher removal rate than that of the already-known oxide, and the present invention has been completed.

### BEST MODE FOR CARRYING OUT THE INVENTION

Although exmples showing specific constitution and effect according to the present invention are described below, the present invention is not limited to these in any way.

### EXAMPLE 1

Manganese sulfate 4 hydrates of 700 g was added to a sedimentation tank which contains 10 L of ion exchanged water, and the solution was stirred to obtain a manganese sulfate solution. In addition, potassium permanganate of 400 g and potassium hydroxide of 460 g were added to a separate sedimentation tank which contains 23 L of ion exchanged water, and the solution was stirred to obtain a potassium permanganate solution. Furthermore, after the potassium permanganate solution was added to the manganese sulfate solution kept at 30° C. while stirring, the combined solution was reacted for 2 hours to produce precipitate. The precipitates was filtered, washed with ion exchanged water, and dried at 120° C. for 14 hours to obtain a manganese compound. The specific surface area of the obtained manganese compound was 420 m²/g, and the content of potassium was 7.8%.

### EXAMPLE 2

A manganese compound was obtained by the same method as in Example 1, except that the added quantity of potassium hydroxide was 230 g. The specific surface area of the obtained manganese compound was 350 m²/g, and the content of potassium was 3.1%.

### EXAMPLE 3

A manganese compound was obtained by the same method as in Embodiment 1, except that manganese nitrate of 900 g was used in place of manganese sulfate 4 hydrates of 700 g in Example. The specific surface area of the obtained manganese compound was 340 m²/g, and the content of potassium was 3.5%.

### EXAMPLE 4

A manganese compound was obtained by the same method as in Example 1, except that sodium hydroxide of 230 g was used in place of potassium hydroxide of 460 g in Example 1. The specific surface area of the obtained manganese compound was 320 m²/g, and the content of sodium was 2.2%.

### COMPARATIVE EXAMPLE 1

The manganese carbonate reagent was sintered in the air at 350° C. for 5 hours. The obtained sintered substance of 200 g was injected to a 0.1 mol/L nitric acid aqueous solution of 1 L and acid treatment was performed by stirring the solution. After the solution was filtered and washed with ion exchanged water, the manganese oxide in Comparative Example 1 was obtained. The specific surface area of the obtained manganese oxide was 150 m²/g.

### COMPARATIVE EXAMPLE 2

The manganese oxide in Comparative Example 2 was obtained by the same method as in Example 1, except that potassium hydroxide was not added to the potassium permanganate aqueous solution in Example 1. The specific surface area of the obtained manganese oxide was 230 m 2/g.

### TEST EXAMPLE 1

<Environmental Pollutant Removal Performance Evaluation>

The performance evaluation of the manganese compound according to the present invention was performed by measuring the removal performance of the environmental pollutants in the air. Namely, the gases having following gas compositions were measured under following measurement conditions. The removal rate of the environmental pollutants was calculated by the following formula. In addition, granulated manganese compound sized 1 to 2 mm was used for the evaluation.

<Test Conditions>
Gas Compositions

| | |
|---|---|
| Ammonia | 20 ppm |
| Hydrogen sulfide | 20 ppm |
| Mercaptan | 20 ppm |
| Acetaldehyde | 20 ppm |
| Formaldehyde | 20 ppm |
| Carbon monooxide | 20 ppm |
| Air | Balance |
| Test temperature | 25° C. |
| Gas space velocity (SV) | 100,000 h⁻¹ |

<Calculation of Environmental Pollutant Removal Rate>
Removal Rate=[(A−B)/A]×100 (%)
wherein, A and B are as follows:
A: The concentration of the environmental pollutants on the inlet side of the reaction tube

B: The concentration of the environmental pollutants on the outlet side of the reaction tube

TABLE 1
Measurement Results of Environmental Pollutant Removal Rates

| | Removal Rate of Environmental Pollutants (%) | | | | | |
|---|---|---|---|---|---|---|
| | | Hydrogen | | | | Carbon |
| | Ammonia | Sulfide | Methylmercaptan | Acetaldehyde | Formaldehyde | Monoxide |
| Example 1 | 90 | 75 | 60 | 65 | 85 | 35 |
| Example 2 | 89 | 70 | 57 | 63 | 81 | 32 |
| Example 3 | 84 | 70 | 55 | 62 | 75 | 28 |
| Example 4 | 85 | 68 | 53 | 60 | 73 | 24 |
| Comparative | 50 | 30 | 20 | 35 | 52 | 9 |
| Example 5 | | | | | | |
| Comparative | 58 | 36 | 28 | 41 | 55 | 4 |
| Example 6 | | | | | | |

### INDUSTRIAL APPLICABILITY

Obtained results indicate that a prepotency of the environmental pollutant removal performance by the manganese compound according to the present invention is significant in comparison with the known manganese oxide, as shown in Table 1.

1. A manganese compound wherein 1 to 10% of an alkaline substance is incorporated into a structure thereof and a BET surface area is 300 m²/g or more.

2. A method of producing a manganese compound wherein an alkali compound and a permanganate are mixed into a bivalent manganese salt aqueous solution under being stirred to produce precipitates by reaction, and the precipitates are filtered after sufficient washing, and then dried,
which is characterized in that a quantity of the alkali compound is larger than a stoichiometric quantity to a permanganate.

3. A method of producing a manganese compound according to claim 2, characterized in that an added quantity of an alkaline compound to a permanganate is in the range of higher than 1.0 but 4.0 or less, when the added quantity is expressed in a mol ratio to an alkaline permanganate of 1 mol.

4. A method of producing a manganese compound according to claim 2, characterized in that a drying temperature is 100 to 200° C.

5. A method of removing environmental pollutants in a gas by allowing the gas containing the environmental pollutants to pass through a manganese compound according to claim 1.
